(19) United States
(12) Patent Application Publication
(10) Pub. No.: US 2025/0355252 A1
(43) Pub. Date: Nov. 20, 2025

(54) MIXED REALITY DISPLAY DEVICE

(71) Applicant: National Central University, Taoyuan City (TW)

(72) Inventors: Ching-Cherng SUN, Taoyuan City (TW); Shiuan-Huei LIN, Hsinchu City (TW); Wei-Chia SU, Changhua County (TW); Yeh-Wei YU, Taoyuan City (TW); Tsung-Hsun YANG, Taoyuan City (TW); Wen-Kai LIN, Taichung City (TW); Shao-Kui ZHOU, Taipei City (TW); Chih-Yuan CHENG, Tainan City (TW); Chih-Hung CHEN, Hsinchu County (TW)

(21) Appl. No.: 18/902,847

(22) Filed: Sep. 30, 2024

(30) Foreign Application Priority Data
May 17, 2024 (TW) 113118470

(51) Int. Cl. G02B 27/01

(52) U.S. Cl. CPC G02B 27/0172; G02B 2027/0174

(57) ABSTRACT

A mixed reality display device includes a first waveguide element, a light source, a first holographic optical element, a couple-in lens assembly and a passive display panel. The light source is located at a side of the first waveguide element. The first holographic optical element is located between the first waveguide element and the light source. The couple-in lens assembly is located at another side of the first waveguide element facing away from the light source. The passive display panel is located at another side of the waveguide element facing away from the light source, in which the passive display panel and the light source are respectively located at two opposite sides of the couple-in lens assembly. A distance between the passive display panel and the couple-in lens assembly are smaller than 10 millimeters.

### CROSS-REFERENCE TO RELATED APPLICATION

This application claims priority to Taiwan Application Serial Number 113118470, filed May 17, 2024, which is herein incorporated by reference.

### BACKGROUND

### Field of Invention

The present disclosure relates to a mixed reality display device.

### Description of Related Art

Generally speaking, in a see-through wearable display, such as mixed reality glasses or augmented reality glasses, etc., whether a display panel in the see-through wearable display is an active light-emitting panel (e.g., an organic light-emitting diode (OLED) display panel, micro light-emitting diode (μLED) display panel) or a passive display panel (e.g., spatial light modulator (SLM), liquid crystal on silicon (LCoS), digital micromirror device (DMD), etc.), the light source of the see-through wearable display is located on the same side as a couple-in lens assembly that couples with a light guide.

However, if the display panel is a passive panel, a light guide element needs to be placed between a coupling lens and the display panel to direct a light beam into the panel. Such a configuration will significantly increase the size of the see-through wearable display.

### SUMMARY

One aspect of the present disclosure provides a mixed reality display device.

According to some embodiments of the present disclosure, a mixed reality display device includes a first waveguide element, a light source, a first holographic optical element, a couple-in lens assembly, and a passive display panel. The light source is located in a light path upstream of the first waveguide element. The first holographic optical element is located on the first waveguide element. The couple-in lens assembly is located at a first side of the first waveguide element facing away from the first holographic optical element. The passive display panel is located at the first side of the first waveguide element facing away from the first holographic optical element, wherein the passive display panel and the light source are respectively located at two different sides of the couple-in lens assembly, and a distance between the passive display panel and the couple-in lens assembly are smaller than 10 millimeters.

In some embodiments, the mixed reality display device further includes a first polarizer, a second holographic optical element, and a second polarizer. The first polarizer is located between the first waveguide element and the light source. The second holographic optical element is located on a second side of the first waveguide element, and the second holographic optical element and the first holographic optical element are located on the same side of the first waveguide element, wherein the second holographic optical element is spaced apart from the first holographic optical element at a distance in a first direction. The second polarizer is located at the first side of the first waveguide element facing away from the second holographic optical element, wherein at least a portion of the second polarizer overlaps the second holographic optical element in a second direction different from the first direction.

In some embodiments, the mixed reality display device further includes an entrance lens located between the light source and the first waveguide element.

In some embodiments, the mixed reality display device further includes a second waveguide element located at a side of the first waveguide element facing away from the couple-in lens assembly.

In some embodiments, the light source and the first waveguide element are located at the same side of the second waveguide element.

In some embodiments, the mixed reality display device further includes an entrance lens located between the light source and the second waveguide element.

In some embodiments, the light source and the couple-in lens assembly are located at the same side of the first waveguide element.

In some embodiments, the mixed reality display device further includes a polarizing beam splitter located at the same side of the first waveguide element as the light source, wherein the polarizing beam splitter overlaps the light source in a first direction, and the polarizing beam splitter overlaps the first waveguide element in a second direction different from the first direction.

In some embodiments, the passive display panel includes at least one of liquid crystal on silicon (LCoS), liquid crystal display (LCD), digital micromirror device (DMD), and spatial light modulator (SLM).

Another aspect of the present disclosure provides a mixed reality display device.

According to some embodiments of the present disclosure, a mixed reality display device includes a first waveguide element, a light source, a first holographic optical element, a couple-in lens assembly, and a passive display panel. The light source is located in a light path upstream of the first waveguide element. The first holographic optical element is located on the first waveguide element. The couple-in lens assembly is located at a first side of the first waveguide element facing away from the first holographic optical element. The passive display panel is located at the first side of the first waveguide element facing away from the first holographic optical element, wherein the passive display panel and the light source are respectively located at two different sides of the first waveguide element, and a distance between the passive display panel and the couple-in lens assembly are smaller than 10 millimeters.

In some embodiments, the mixed reality display device further includes a first polarizer, a second holographic optical element, and a second polarizer. The first polarizer is located between the first waveguide element and the light source. The second holographic optical element is located on a second side of the first waveguide element, and the second holographic optical element and the first holographic optical element are located on the same side of the first waveguide element, wherein the second holographic optical element is spaced apart from the first holographic optical element at a distance in a first direction. The second polarizer is located at the first side of the first waveguide element facing away from the second holographic optical element, wherein at least a portion of the second polarizer overlaps the second holographic optical element in a second direction different from the first direction.

In some embodiments, the mixed reality display device further includes an entrance lens located between the light source and the first waveguide element.

In some embodiments, the mixed reality display device further includes a second waveguide element located at a side of the first waveguide element facing away from the couple-in lens assembly.

In some embodiments, the light source and the first waveguide element are located at the same side of the second waveguide element.

In some embodiments, the mixed reality display device further includes an entrance lens located between the light source and the second waveguide element.

In some embodiments, the mixed reality display device further includes a polarizing beam splitter located at the same side of the first waveguide element as the light source, wherein the polarizing beam splitter overlaps the light source in a first direction, and the polarizing beam splitter overlaps the first waveguide element in a second direction different from the first direction.

In the aforementioned embodiments of the present disclosure, since the passive display panel and the light source are respectively located at two opposite sides of the first waveguide element, it is no longer necessary to place a light guide element in a mixed reality display device for guiding images into a couple-in lens assembly, and the size of the mixed reality display device can be significantly reduced, which facilitates the miniaturization of the device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a cross-sectional view of a mixed reality display device according to one embodiment of the present disclosure.

FIG. 2 is a cross-sectional view of a mixed reality display device according to another embodiment of the present disclosure.

FIG. 3 is a cross-sectional view of a mixed reality display device according to still another embodiment of the present disclosure.

FIG. 4 is a cross-sectional view of a mixed reality display device according to yet another embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

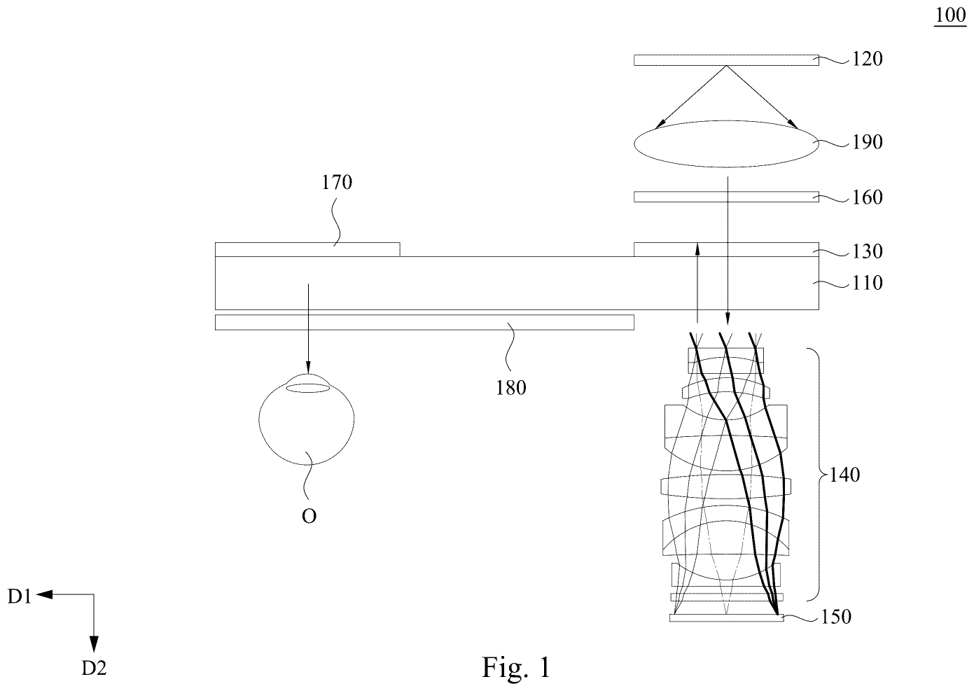

FIG. 1 is a cross-sectional view of a mixed reality display device 100 according to one embodiment of the present disclosure. As shown in FIG. 1, the mixed reality display device 100 includes a first waveguide element 110, a light source 120, a first holographic optical element 130, a couple-in lens assembly 140, and a passive display panel 150. The light source 120 is located at one side of the first waveguide element 110 (e.g., in a light path upstream of the first waveguide element 110). The first holographic optical element 130 is located between the first waveguide element 110 and the light source 120. The couple-in lens assembly 140 is located at another side (e.g., a first side) of the first waveguide element 110 facing away from the light source 120. The passive display panel 150 is located at the first side of the first waveguide element 110 facing away from the light source 120, in which the passive display panel 150 and the light source 120 are respectively located at two opposite sides of the couple-in lens assembly 140, and a distance between the passive display panel 150 and the couple-in lens assembly 140 are smaller than 10 millimeters, such as in a range from 100 micrometers to 10 millimeters. In this embodiment, the mixed reality display device 100 further includes a first polarizer 160, a second holographic optical element 170, a second polarizer 180, and an entrance lens 190. The first polarizer 160 is located between the first waveguide element 110 and the light source 120. The second holographic optical element 170 is located on the first waveguide element 110 (e.g., a second side of the first waveguide element 110), and the second holographic optical element 170 and the first holographic optical element 130 are located on the same side of the first waveguide element 110, in which the second holographic optical element 170 is spaced apart from the first holographic optical element 130 at a distance in a first direction D1. The second polarizer 180 is located at the first side of the first waveguide element 110 facing away from the second holographic optical element 170, in which at least a portion of the second polarizer 180 overlaps the second holographic optical element 170 in a second direction D2 that is different from the first direction. In some embodiments, the first direction is perpendicular to the second direction D2. The entrance lens 190 is located between the light source 120 and the first waveguide element 110.

In this embodiment, the light source 120 is a white light source, and may be a point light source or a surface light source. The light emitted by the light source 120 enters the first holographic optical element 130, and directly passes through the first holographic optical element 130 to enter the couple-in lens assembly 140. The couple-in lens assembly 140 converts the incident light into a uniform plane wave, and then the light irradiates the passive display panel 150. The passive display panel 150 reflects the light to form an image, such that the image reaches the first holographic optical element 130. At this moment, the first holographic optical element 130 can couple the image into the first waveguide element 110 to transmit the image to the second holographic optical element 170, and then the second holographic optical element 170 couples the image out to an observer O. Furthermore, in this embodiment, the first polarizer 160 is a P-polarization state polarizer, and the second polarizer 180 is an S-polarization state polarizer. Moreover, the passive display panel 150 includes at least one of liquid crystal on silicon (LCoS), liquid crystal display (LCD), digital micromirror device (DMD), and spatial light modulator (SLM).

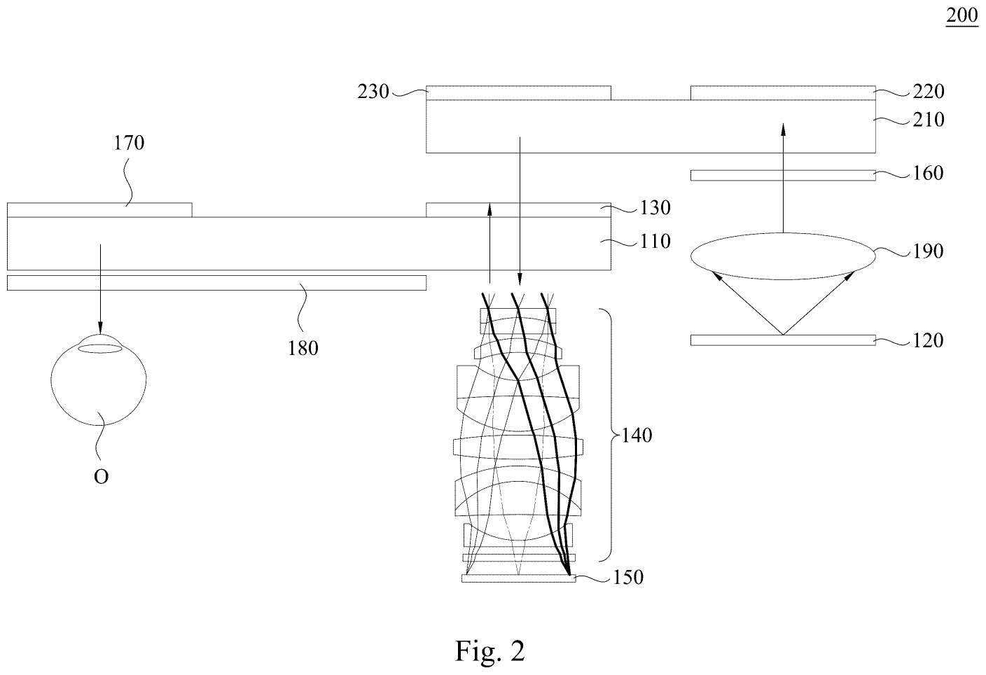

FIG. 2 is a cross-sectional view of a mixed reality display device 200 according to another embodiment of the present disclosure. As shown in FIG. 2, the mixed reality display device 200 includes the first waveguide element 110, the light source 120, the first holographic optical element 130, the couple-in lens assembly 140, the passive display panel 150, the first polarizer 160, the second holographic optical element 170, the second polarizer 180, and the entrance lens 190. The difference between this embodiment and the embodiment of FIG. 1 is that the mixed reality display device 200 in this embodiment further includes a second waveguide element 210, a third holographic optical element 220, and a fourth holographic optical element 230. The second waveguide element 210 is located at a side of the first waveguide element 110 facing away from the couple-in lens assembly 140. In other words, the light source 120 and the first waveguide element 110 are located at the same side of the second waveguide element 210. The third holographic optical element 220 is located at a side of the second waveguide element 210 facing away from first waveguide element 110. The fourth holographic optical element 230 is located at a side of the second waveguide element 210 facing away from first waveguide element 110, and the fourth holographic optical element 230 is spaced apart from the third holographic optical element 220 at a distance in the first direction D1 (see FIG. 1). The third holographic optical element 220 overlaps at least partially overlaps the light source 120, the entrance lens 190, and the first polarizer 160 in the direction D2 (see FIG. 1) different from the direction D1. In addition, the entrance lens 190 is located between the light source 120 and the second waveguide element 210.

In this embodiment, the light source 120 is a white light source, and may be a point light source or a surface light source. After the light emitted by the light source 120 passes through the entrance lens 190 and the first polarizer 160, the light is coupled into the second waveguide element 210 by the third holographic optical element 220, and the light is transmitted to the fourth holographic optical element 230. After the fourth holographic optical element 230 couples out the light, the light passes through the first holographic optical element 130 to enter the couple-in lens assembly 140. The couple-in lens assembly 140 converts the incident light into a uniform plane wave, and then the light irradiates the passive display panel 150. Moreover, in this embodiment, the first polarizer 160 is a P-polarization state polarizer, and the second polarizer 180 is an S-polarization state polarizer.

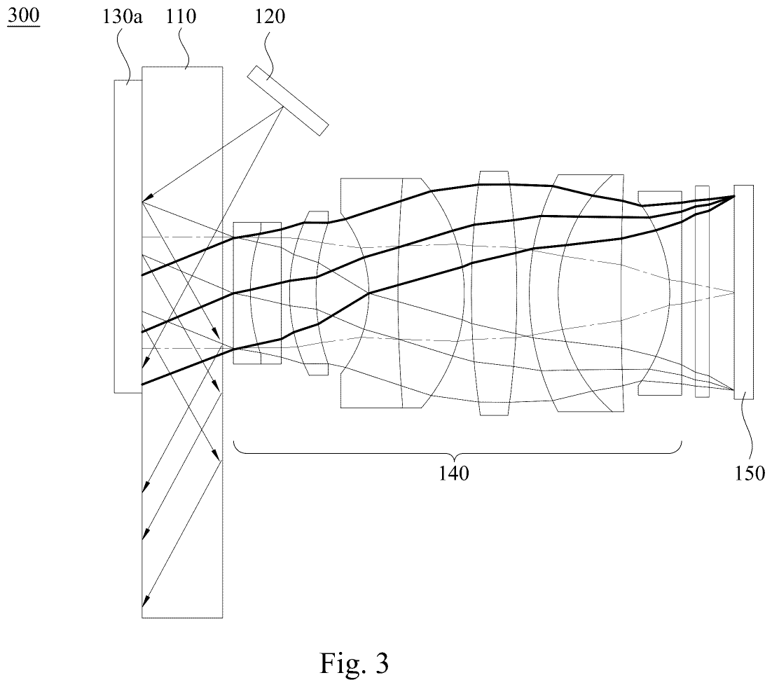

FIG. 3 is a cross-sectional view of a mixed reality display device 300 according to still another embodiment of the present disclosure. As shown in FIG. 3, the mixed reality display device 300 includes the first waveguide element 110, the light source 120, a first holographic optical element 130a, the couple-in lens assembly 140, and the passive display panel 150. The difference between this embodiment and the embodiment of FIG. 1 is that the light source 120 and the couple-in lens assembly 140 in this embodiment are located at the same side of the first waveguide element 110. In this embodiment, the light source 120 is a white point light source. After the light emitted by the light source 120, the light reaches the first holographic optical element 130a. At this moment, the first holographic optical element 130a directs the light to the couple-in lens assembly 140 to form a uniform plane wave. Thereafter, the passive display panel 150 reflects the light to form an image, such that the image reaches the first holographic optical element 130a. At this moment, the first holographic optical element 130a can couple the image into the first waveguide element 110.

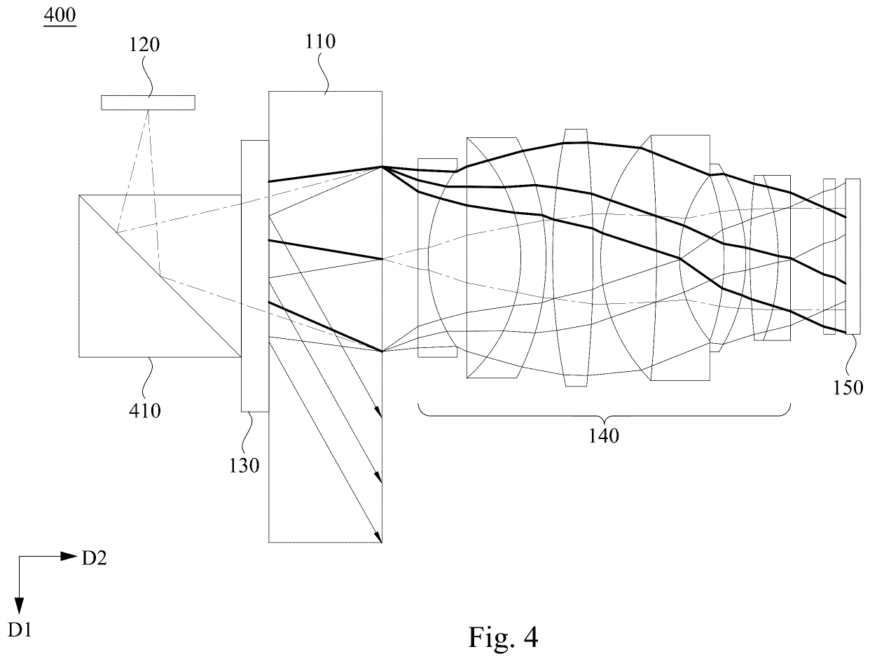

FIG. 4 is a cross-sectional view of a mixed reality display device 400 according to yet another embodiment of the present disclosure. As shown in FIG. 4, the mixed reality display device 400 includes the first waveguide element 110, the light source 120, the first holographic optical element 130, the couple-in lens assembly 140, and the passive display panel 150. The difference between this embodiment and the embodiment of FIG. 1 is that the mixed reality display device 400 in this embodiment further includes a polarizing beam splitter 410. The polarizing beam splitter 410 is located at the same side of the first waveguide element 110 as the light source 120, in which the polarizing beam splitter 410 overlaps the light source 120 in the first direction D1, and the polarizing beam splitter 410 overlaps the first waveguide element 110 in the second direction D2 different from the first direction D1. In this embodiment, the light source 120 is a white point light source, and is disposed on an equivalent front focal plane of the couple-in lens assembly 140. After the light emitted by the light source 120 passes through the polarizing beam splitter 410, the light passes through the first holographic optical element 130, and then a uniform plane wave formed from the couple-in lens assembly 140 irradiates the passive display panel 150. Thereafter, the passive display panel 150 reflects the light to form an image, such that the image passes through the couple-in lens assembly 140 to reach the first holographic optical element 130, and is coupled into the first waveguide element 110.

Since the passive display panel and the light source are respectively located at two opposite sides of the first waveguide element, it is no longer necessary to place a light guide element in a mixed reality display device for guiding images into a couple-in lens assembly, and the size of the mixed reality display device can be significantly reduced, which facilitates the miniaturization of the device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A mixed reality display device, comprising:
a first waveguide element;
a light source located in a light path upstream of the first waveguide element;
a first holographic optical element located on the first waveguide element;
a couple-in lens assembly located at a first side of the first waveguide element facing away from the first holographic optical element; and
a passive display panel located at the first side of the first waveguide element facing away from the first holographic optical element, wherein the passive display panel and the light source are respectively located at two different sides of the couple-in lens assembly, and a distance between the passive display panel and the couple-in lens assembly are smaller than 10 millimeters.

2. The mixed reality display device of claim 1, further comprising:
a first polarizer located between the first waveguide element and the light source;
a second holographic optical element located on a second side of the first waveguide element, the second holographic optical element and the first holographic optical element located on the same side of the first waveguide element, wherein the second holographic optical element is spaced apart from the first holographic optical element at a distance in a first direction; and
a second polarizer located at the first side of the first waveguide element facing away from the second holographic optical element, wherein at least a portion of the second polarizer overlaps the second holographic optical element in a second direction different from the first direction.

3. The mixed reality display device of claim 1, further comprising:
an entrance lens located between the light source and the first waveguide element.

4. The mixed reality display device of claim 1, further comprising:
a second waveguide element located at a side of the first waveguide element facing away from the couple-in lens assembly.

5. The mixed reality display device of claim 4, wherein the light source and the first waveguide element are located at the same side of the second waveguide element.

6. The mixed reality display device of claim 5, further comprising:
an entrance lens located between the light source and the second waveguide element.

7. The mixed reality display device of claim 1, wherein the light source and the couple-in lens assembly are located at the same side of the first waveguide element.

8. The mixed reality display device of claim 1, further comprising:
a polarizing beam splitter located at the same side of the first waveguide element as the light source, wherein the polarizing beam splitter overlaps the light source in a first direction, and the polarizing beam splitter overlaps the first waveguide element in a second direction different from the first direction.

9. The mixed reality display device of claim 1, wherein the passive display panel comprises at least one of liquid crystal on silicon (LCoS), liquid crystal display (LCD), digital micromirror device (DMD), and spatial light modulator (SLM).

10. A mixed reality display device, comprising:
a first waveguide element;
a light source located in a light path upstream of the first waveguide element;
a first holographic optical element located on the first waveguide element;
a couple-in lens assembly located at a first side of the first waveguide element facing away from the first holographic optical element; and
a passive display panel located at the first side of the first waveguide element facing away from the first holographic optical element, wherein the passive display panel and the light source are respectively located at two different sides of the first waveguide element, and a distance between the passive display panel and the couple-in lens assembly are smaller than 10 millimeters.

11. The mixed reality display device of claim 10, further comprising:
a first polarizer located between the first waveguide element and the light source;
a second holographic optical element located on a second side of the first waveguide element, the second holographic optical element and the first holographic optical element located on the same side of the first waveguide element, wherein the second holographic optical element is spaced apart from the first holographic optical element at a distance in a first direction; and
a second polarizer located at the first side of the first waveguide element facing away from the second holographic optical element, wherein at least a portion of the second polarizer overlaps the second holographic optical element in a second direction different from the first direction.

12. The mixed reality display device of claim 10, further comprising:
an entrance lens located between the light source and the first waveguide element.

13. The mixed reality display device of claim 10, further comprising:
a second waveguide element located at another side of the first waveguide element facing away from the couple-in lens assembly.

14. The mixed reality display device of claim 13, wherein the light source and the first waveguide element are located at the same side of the second waveguide element.

15. The mixed reality display device of claim 14, further comprising:
an entrance lens located between the light source and the second waveguide element.

16. The mixed reality display device of claim 10, further comprising:
a polarizing beam splitter located at the same side of the first waveguide element as the light source, wherein the polarizing beam splitter overlaps the light source in a first direction, and the polarizing beam splitter overlaps the first waveguide element in a second direction different from the first direction.
